(19) United States
(12) Patent Application Publication
(10) Pub. No.: US 2016/0028678 A1
(43) Pub. Date: Jan. 28, 2016

(54) ELECTRONIC MAIL SENDING DEVICE

(71) Applicant: KYOCERA DOCUMENT SOLUTIONS INC., Osaka (JP)

(72) Inventors: Naoto HANADA, Osaka (JP); Keiko MORITA, Osaka (JP)

(21) Appl. No.: 14/782,309

(22) PCT Filed: Nov. 21, 2014
(86) PCT No.: PCT/JP2014/080838

§ 371 Date: Oct. 2, 2015

(30) Foreign Application Priority Data
Nov. 29, 2013 (JP) 2013-246924
Jul. 3, 2014 (JP) 2014-137422

(51) Int. Cl. H04L 12/58; H04L 12/18

(52) U.S. Cl. CPC H04L 51/28; H04L 12/185

(57) ABSTRACT

An object of the present invention is to provide an electronic mail sending device able to simply confirm and correct a designated destination. To this end, an electronic mail sending device (10) is used which is able to set a destination (mail address) of an electronic mail using address data (30) in which a plurality of address records are previously registered. Group information composed of a plurality of group items is registered together with destinations in the address records. A mail generation part (20) that compares a common item in the group information whose destination has already been set with the group information whose destination is newly set when a new destination is designated in a state where a destination is set. When both group information is inconsistent with each other, the electronic generation part (20) causes a display part (13) to display a warning screen, newly designated and notifies inconsistency between both group information.

### BACKGROUND OF THE INVENTION

1. Field of the Invention

The present invention relates to an electronic mail sending device such as a personal computer, a printer, and a MFP (multiple function printer) having an electronic mail sending function.

2. Description of the Related Art

Recently, not only personal computer but also printer and MFP or the like are connected to a network such as the Internet, and function as an electronic mail sending device having an electronic mail sending function. Such electronic mail sending device generally has an address book function for registration of destinations (mail addresses) and are configured to designate a destination of an electronic mail using the address book function. The use of the address book function allows simple designation of the destination by merely selecting a desired destination from the registered destinations. However, it sometimes happens that an unintended destination is inadvertently designated and sent thereto because of a mere simple selecting operation. To prevent the inadvertent designation of the unintended destination, there has been proposed a destination designation support method that prompts a user to confirm and correct a designated destination using group information registered together with the destinations (mail addresses) (see, for example, Patent Literature 1).

### CITATION LIST

### Patent Literature

Patent Literature 1: JP2006-309365A

### SUMMARY OF THE INVENTION

### Problems to be Solved by the Invention

In the technique of Patent Literature 1, however, a warning is displayed to prompt a user to confirm and correct the destination using rule data defining a relationship between groups registered together with destinations (mail addresses). Accordingly, such technique requires to a user to perform a complicated work to previously define the relationship between the groups, and an electronic mail is used in various applications. Thus, there remains a problem that previously defining the relationship between the groups for all the possible applications is substantially difficult.

The present invention is made in view of the above circumstances, and an object of the present invention is to provide an electronic mail sending device able to simply confirm and correct a designated destination using group items registered together with destinations (mail addresses) when a destination of an electronic mail address is designated.

### Means for Solving the Problems

In order to solve the above problems, there is provided an electronic mail sending device able to set a destination of an electronic mail address using address data in which a plurality of address records are previously registered including the address records in which a group information composed of a plurality of group items are registered together with the destination; and a mail generation means that compares a common item in the group information whose destination has already been set with the group information whose destination is newly designated when the new destination is designated in a state where the destination has already been set, and notifies a warning when both group information is inconsistent with each other.

### Effect of the Invention

According to the present invention, since the present invention can notify a user that there is a possibility that a newly designated destination does not belong to the same group to which the already set destination belongs, and that common items in the group information whose destination has already been set are extended, the present invention exerts an effect of enabling inadvertent setting of a destination caused by a user to be prevented beforehand.

### BRIEF DESCRIPTION OF DRAWINGS

FIG. 1 is a block diagram showing an internal configuration of an embodiment of an electronic mail sending device according to the present invention;

FIG. 2 is a data configuration diagram showing a configuration of address data shown in FIG. 1;

FIG. 3 is a flow chart explaining a destination setting operation by a mail generation part shown in FIG. 1;

FIG. 4A is an explanation diagram showing setting of a destination and an example of designation by the mail generation part shown in FIG. 1;

FIG. 4B is an expiation diagram showing setting of a destination and an example of designation by the mail generation part shown in FIG. 1;

FIG. 4C is an explanation diagram showing setting of a destination and an example of designation by the mail generation part shown in FIG. 1;

FIG. 4D is an explanation diagram showing setting of a destination and an example of destination designation by the mail generation part shown in FIG. 1;

FIG. 5A is a view showing an example of a warning screen displayed on a display part shown in FIG. 1; and

FIG. 5B is a view showing an example of a warning screen displayed on a display part shown in FIG. 1.

### MODE FOR CARRYING OUT THE INVENTION

Exemplary embodiments of the present invention will be specifically described with reference to the accompanying drawings.

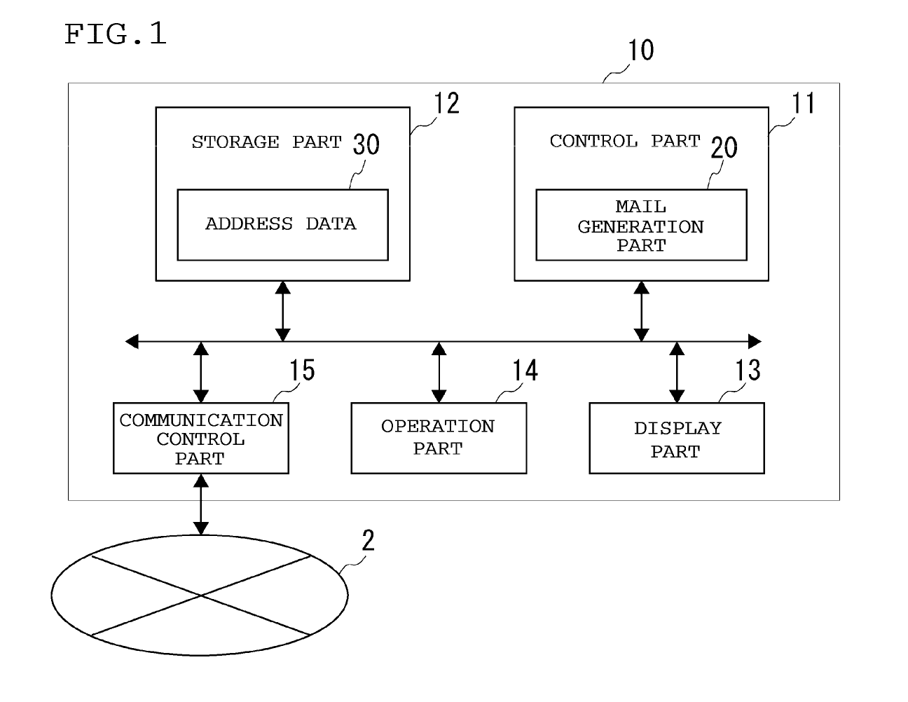

An electronic mail sending device 10 of the present embodiment is an electronic device such as a personal computer, a printer, a MFP (Multiple Function Printer), and includes a control part 11, a storage part 12, a display part 13, an operation part 14, and a communication control part 15 as shown in FIG. 1.

The control part 11 is an information processing part such as a microcomputer provided with a ROM (Read Only Memory) and a RAM (Random Access Memory). A control program that controls an operation of the electronic mail sending device 10 is stored in the ROM of the control part 11. The control part 11 reads the control program stored in the ROM and expands the control program on the RAM to thereby control the whole device according to predetermined instruction information input by the operation part 14. The operation part 14 is made, for example, of a hard key or a touch panel provided so as to overlap on a display panel of the display part 13.

The storage part 12 is a storage means such as a semiconductor memory or a HDD (for example, Hard Disk Drive). Address data 30 in which a plurality of destinations (mail addresses) are registered are stored in the storage part 12. The address data 30 is registered by an input from the operation part 14 and from the outside, for example, through a network 2.

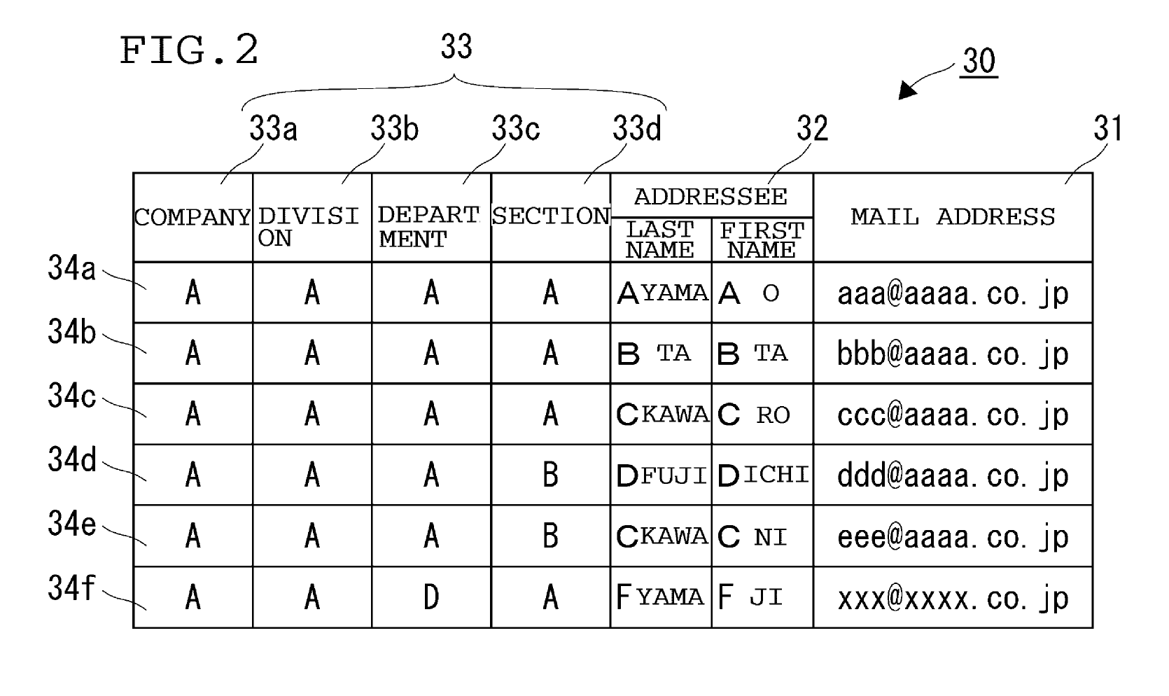

As shown in FIG. 2, the address data 30 stores, as one address record, a mail address 31 that is a destination, an addressee specifying item 32 specifying an addressee, and group information 33 specifying a group to which an addressee belongs. In an example shown in FIG. 2, six address records 34a to 34f are registered. The addressee specifying item 32 is composed of two items of “last name” and “first name” of an addressee. The group information 33 is composed of a plurality of group items 33a to 33d. A highest-order group item 33a is “COMPANY,” and is segmented sequentially into “DIVISION,” “DEPARTMENT,” and “SECTION” as going toward lower-order group items, that is, group items 33b to 33d obtained by further grouping the higher-order group.

The communication control part 15 is composed, for example, of a modem or an I/O controller, and has a function to execute a predetermined protocol based on an instruction from the control part 11 and to send an electronic mail through the network 2.

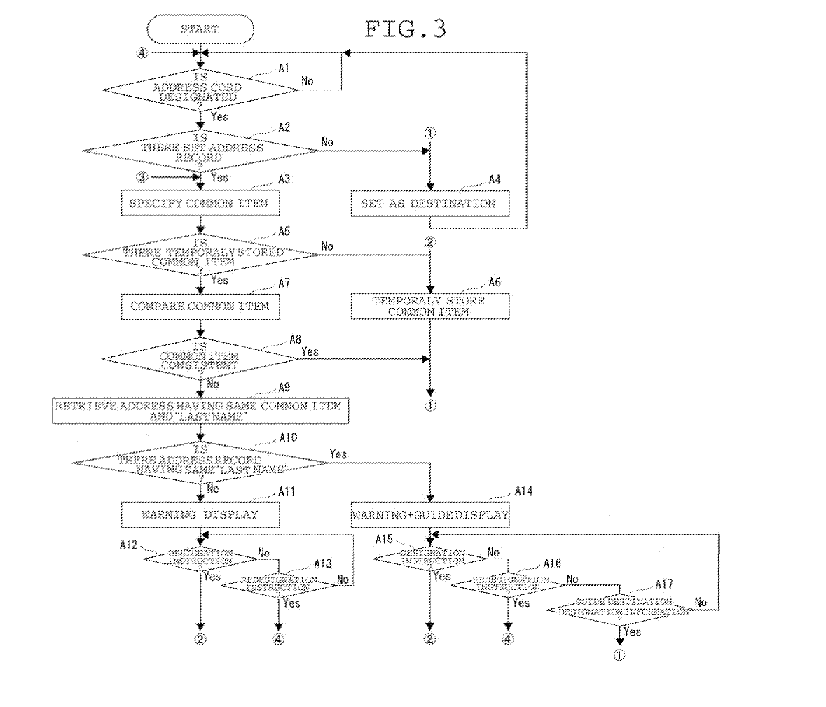

The control part 11 functions as a mail generation part 20 generating an electronic mail, causes the display part 13 to display a part or the whole of the address data 30 stored in the storage part 12, and sets, as a destination of an electronic mail, an address record designated by the operation part 14 from among the address data 30. Hereinbelow, a destination setting operation by the mail generation part 20 will be described in detail with reference to FIGS. 3 to 6.

Referring to FIG. 3, when setting of a destination using the address data 30 is instructed by the operation part 14, the mail generation part 20 causes the display part 13 to display a part or the whole of the address data 30 stored in the storage part 12, and waits until an address record is designated by a user (step A1).

If a user designates any one of the address records 34a to 34f using the operation part 14, the mail generation part 20 determines whether or not there is an already set address record, that is, an address record containing a mail address 31 set as a destination of an electronic mail (step A2).

If it is determined in step A2 that there is no already set address record, that is, at the time of setting of a first destination, the mail generation part 20 sets in step A1 a mail address 31 in the designated address record as a destination (step A4) out of the address records 34a to 34f, returns back to step A1, and waits until a next address record is designated.

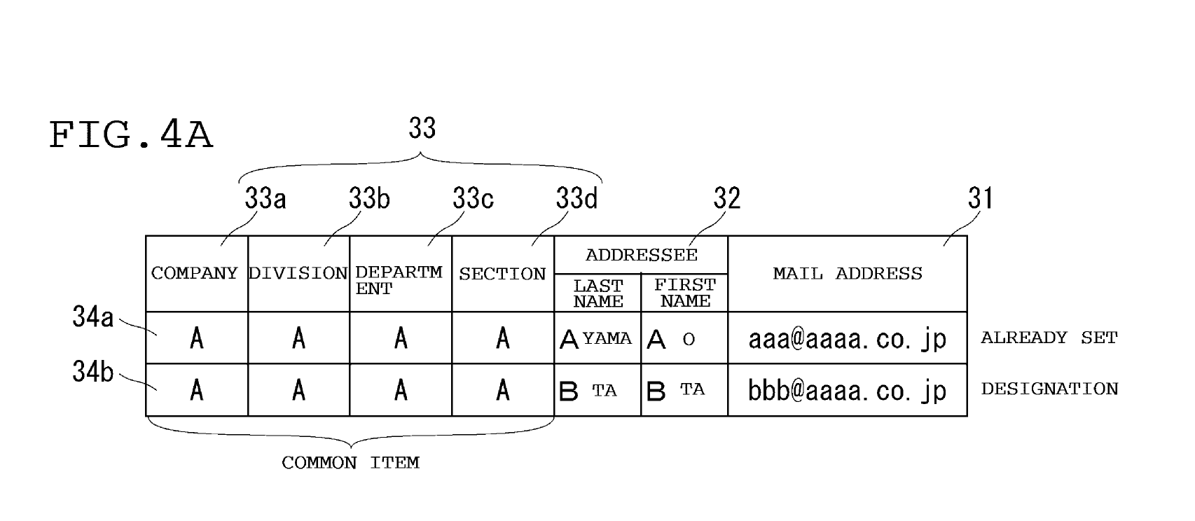

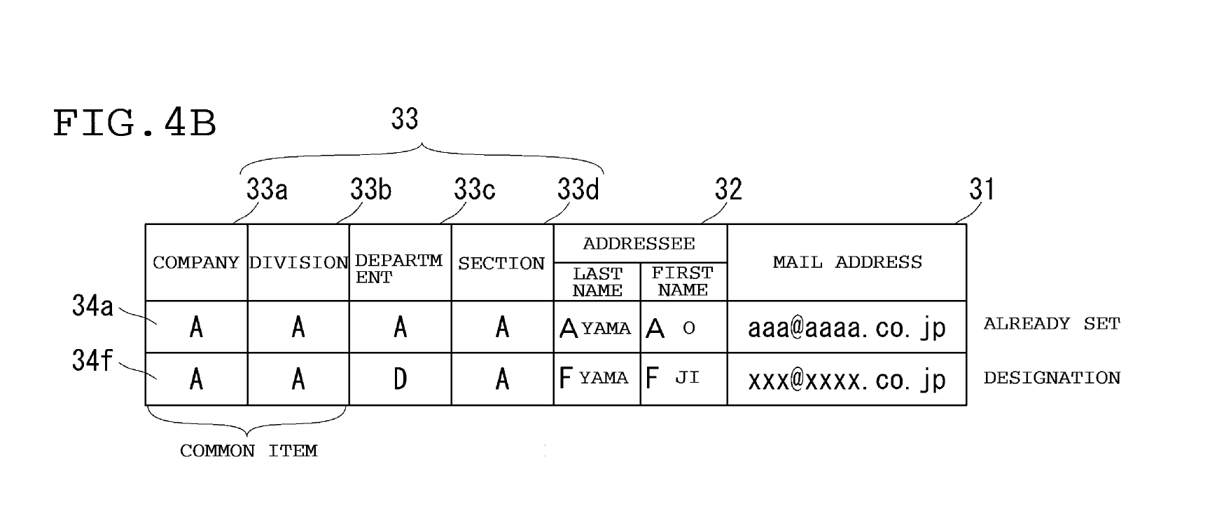

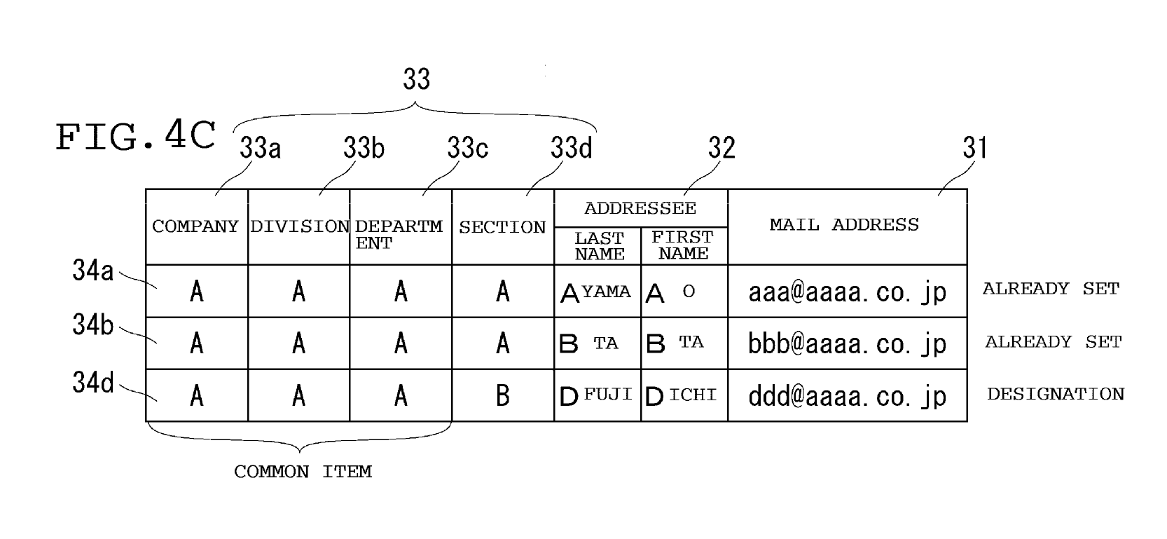

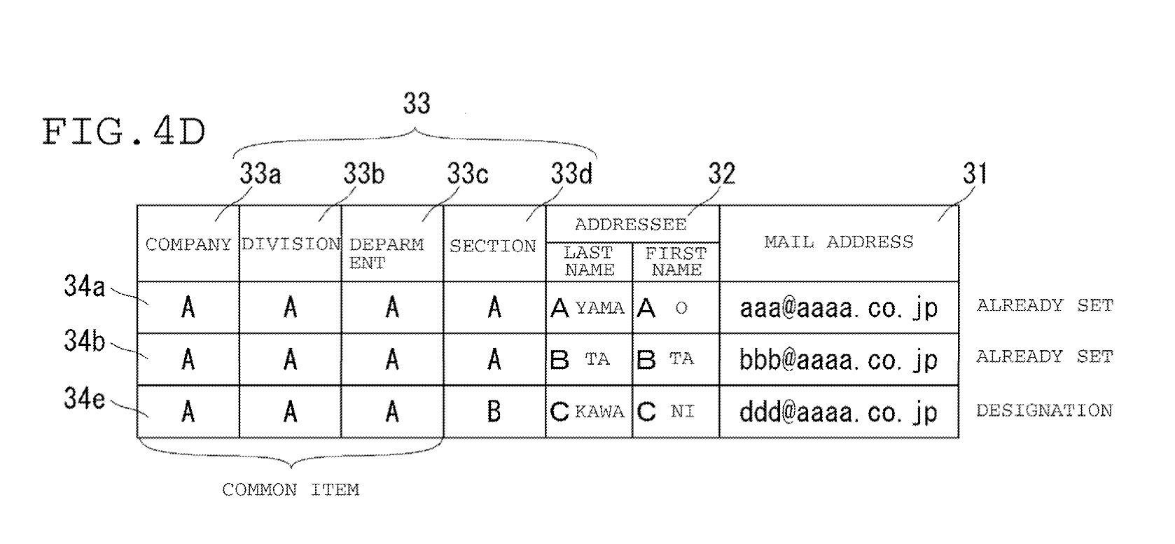

Otherwise, if it is determined in step A2 that there is an already set address record, the mail generation part 20 specifies common items between the group information 33 in the already set address record and the group information 33 designated in step A1 (step A3). For example, as shown in FIG. 4A, if an address record 34b is set in a state where an address record 34a has already been set, four group items 33a to 33d of “COMPANY,” “DIVISION,” “DEPARTMENT,” and “SESSION” are specified in step A3 as common items. In step A3, the group items 33a to 33d are successively determined whether or not an item is a common item from higher to lower group items. Accordingly, as shown in FIG. 4B, if an address record 34f is set in a state where the address record 34a has already been set, the group item 33d of “SESSION” is common, but the group item 33c of “DEPARTMENT” higher than “SESSION” is inconsistent. Thus, two group items 33a and 33b of “COMPANY” and “DIVISION” are specified as common items. If there are a plurality of already set address records, a common item common throughout all the address records is specified.

Next, the mail generation part 20 determines whether or not there is a temporally stored common item (step A5). If it is determined in step A5 that there is no temporally stored common item, the mail generation part 20 temporally stores the common item specified in step A3 in a storage area such as a RAM (step A6). The process then proceeds to step A4 where the mail generation part 20 sets, as a destination, the mail address 31 in the address record designated in step A1.

Otherwise, if it is determined in step A5 that there is a temporally stored common item, the mail generation part 20 compares the common item specified in step A3 with the temporally stored common item (step A7) to determine whether or not both common items are consistent with each other (step A8). If it is determined in step A8 that both common items are consistent, the process proceeds to step A4 where the mail generation part 20 sets, as a destination, the mail address 31 of the address records 34a to 34f designated in step A1.

Otherwise, if it is determined in step A8 that both common items are inconsistent with each other, the mail generation part 20 retrieves an address record having the same “last name” of an addressee as the last name in the addressee specifying item 32 in the address records designated in step A1 from among the address records 34a to 34f having the common item temporally stored in step A6 (step A9), and determines whether or not there are the address records 34a to 34f having the same “last name” of the addressee as the last name of the address records designated in step A1 (step A10).

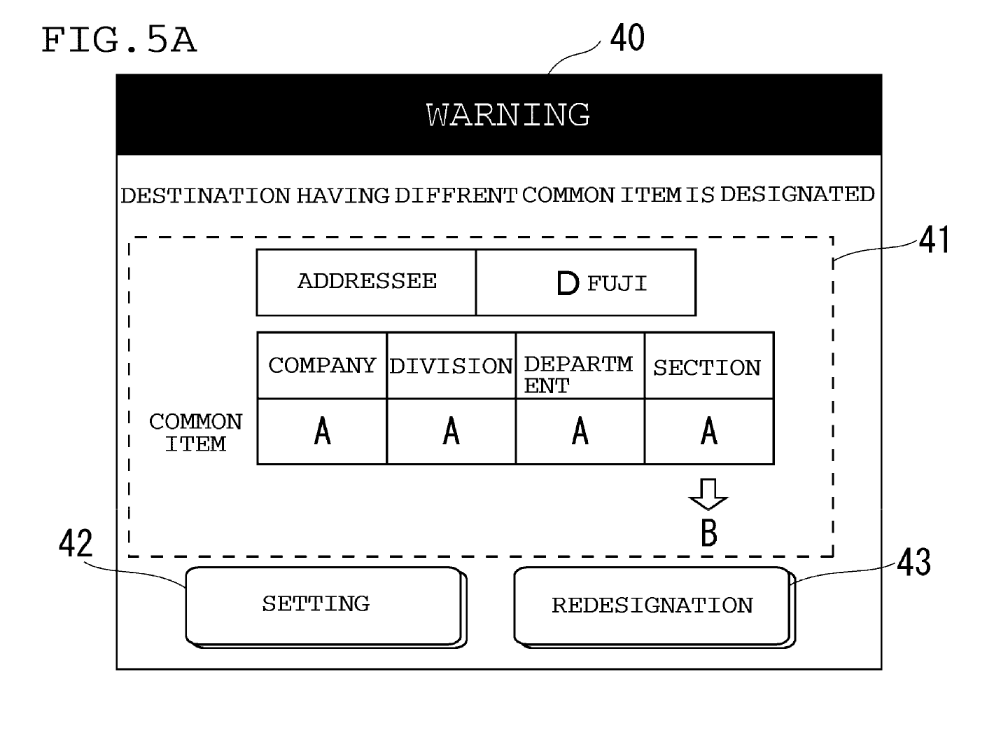

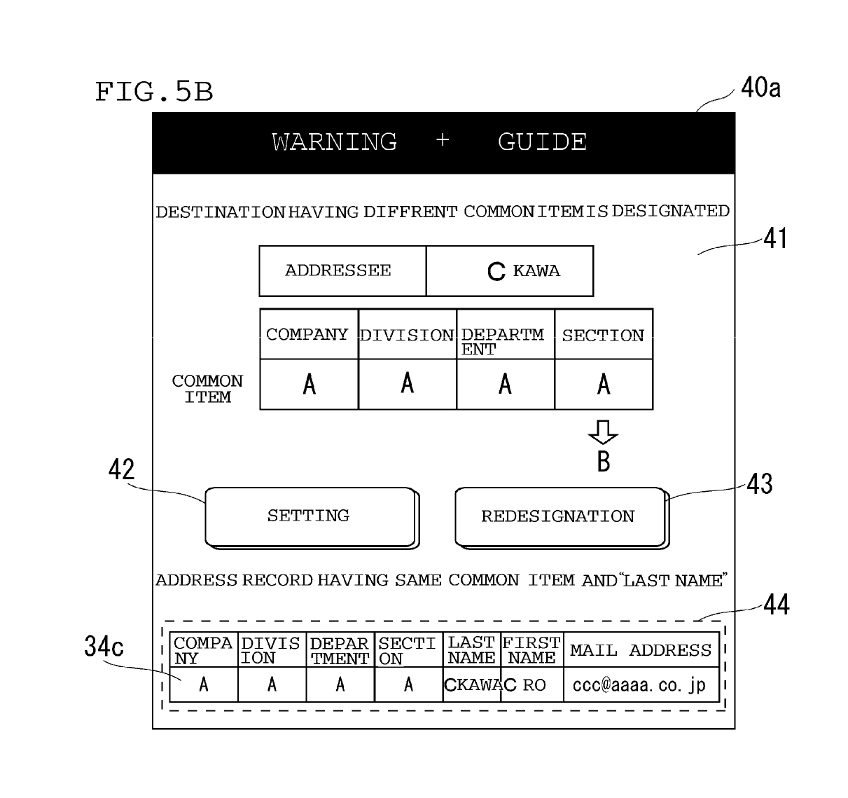

If it is determined in step A10 that there are no address records 34a to 34f having the same “last name” of the addressee, the mail generation part 20 causes the display part 13 to display a warning screen 40 shown in FIG. 5A, and notifies a user that a destination having a different common item is designated (step A11). The warning screen 40 includes an inconsistent item notification area 41 on which group items 33a to 33d inconsistent between the temporally stored common items and the common items specified in step A3 are notified, a setting instruction key 42 instructing setting of the address record specified in step A1, and a redesignation instruction key 43 which cancels the address record designated in step A1 and instructs redesignation of new address records 34a to 34f. For example, as shown in FIG. 4C, if the address record 34d is designated in a state where the address records 34a and 34b have already been set, the warning screen 40 shown in FIG. 5A is displayed on the display part 13 and inconsistency of “SESSION” of the group item 33d is notified on the inconsistent item notification area 41.

A user recognizes through the warning screen 40 that a destination having a different common item is designated, and performs an operation of either a setting instruction key 42 or a redesignation instruction key 43. If the warning screen 40 is displayed on the display part 13 in step A11, the mail generation part 20 waits until an operation of the setting instruction key 42 and an operation of the redesignation instruction key 43 are received (steps A12 and A13). If the mail generation part 20 receives an operation of the setting instruction key 42 in step 12, the process of the mail generation part 20 proceeds to step A6 where the common item specified in step A3 is updated and is temporally stored in the storage area such as RAM, and, at the same time, sets, as a destination, the mail address 31 of the address record specified in step A1 (step A4). Further, if the mail generation part 20 receives an operation of the redesignation instruction key 43 in step A13, the process of the mail generation part 20 returns back to step A1, and waits until new address records 34a to 34f are designated.

If it is determined in step A10 that there are the address records 34a to 34f having the same “last name” of the addressee, the mail generation part 20 causes the display part 13 to display a warning+guide screen 40a shown in FIG. 5B, notifies a user that a destination having a different common item is designated, and, at the same time, notifies an address record having the same “last name” of the addressee as the last name in the address record specified in step A1 (step A14). In the warning+guide screen 40a, in addition to the warning screen 40, there is provided a guide destination designation area 44 on which an address record having the same “last name” of the addressee as the last name in the address record designated in step A1 is notified as a guide destination, and to which designation of the guide destination is received. For example, as shown in FIG. 4D, if an address record 34e is designated in a state where the address records 34a,34b have already been set, the warning+guide screen 40a shown in FIG. 5B is displayed on the display part 13, notifies inconsistency of “SESSION” of the group item 33d on the inconsistent item notification area 41, and, at the same time, notifies, as a guide destination, an address record 34c having the same “last name” of the addressee on the inconsistent item notification area 41.

A user recognizes through the warning+guide screen 40a that a destination having a different common item is designated, at the same time, that there are the address record 34a to 34f having the same “last name” of the addressee present, performs an operation of any of the setting instruction key 42 and the redesignation instruction key 43, and a designation operation of a guide destination in the guide destination designation area 44. After the warning+guide screen 40a is displayed on the display part 13 in step A14, the mail generation part 20 waits until an operation of the setting instruction key 42, an operation of the redesignation instruction key 43, and a designation operation of a guide destination in the guide destination designation area 44 are received (steps A15, A16, and A17). Upon reception of an operation of the setting instruction key 42 in step A15, the mail generation part 20 proceeds to step A6 where the common item specified in step A3 is updated and temporally stored in a storage area such as a RAM, and, at the same time, a mail address 31 of the address record designated in step A1 is set as a destination (step A4). Upon reception of an operation of the redesignation instruction key 43 in step A16, the mail generation part 20 returns back to step A1 and waits until new address records 34a to 34f are designated. Further, upon reception of an operation of a guide destination in step A17, the mail generation part 20 sets the mail address 31 of the designated address record as a destination (step A4).

While the present embodiment is configured such that the addressee specifying item 32 are limited to two items of “last name” and “first name” of the addressee, and retrieval is made for the address records 34a to 34f having the same “last name”, retrieval may be made instead for the address records 34a to 34f having the same “first name”. Alternatively, other items specifying an addressee such as “nickname” may be set as the addressee specifying item 32 and retrieval may be made for the address records 34a to 34f having the set same other items.

As described above, according to the present embodiment, the present embodiment provides an electronic mail sending device 10 able to set a destination of an electronic mail address (mail address 31) using address data 30 in which a plurality of address records 34a to 34f are previously registered including the address records 34a to 34f in which group information 33 composed of a plurality of group items 33a to 33d are registered together with the destination; and a mail generation part 20 that compares a common item of the group information 33 whose destination has already been set with the group information 33 whose destination is newly designated when a new destination is designated in a state where the destination has already been set, and causes the display part 13 to display the warning screen 40 when the both group information is inconsistent with each other, and notifies inconsistency between the both group information.

According to the configuration, since the configuration can notify a user that there is a possibility that the newly designated destination does not belong to the same group to which the already set destination belongs, and that the common items in the group information 33 whose destination has already been set are extended, the configuration allows inadvertent setting of a destination caused by a user to be prevented beforehand.

Further, according to the present embodiment, the present embodiment is configured such that the address records 34a to 34f includes “last name” and “first name” of the addressee registered together with the destination (mail address 31) as the plurality of addressee specifying items 32 specifying the addressee; and the mail generation part 20 that retrieves the address records 34a to 34f having the same common items, and notifies, as a guide destination, the address records 34a to 34f having the same “last name” of the addressee as the last name of the newly designated destination when the common items of the group information 33 whose destination has already been set are inconsistent with the group information 33 whose destination is newly designated.

According to the configuration, since the configuration enables the address records 34a to 34f having the same common items and “last name” of the addressee in the addressee specifying item 32 to be weighed, the configuration allows inadvertent setting of a destination caused by a user to be prevented beforehand, thereby simply setting a correct destination.

While in the above embodiment, the description was made so as to weigh the address records 34a to 34f having the same “last name”, the embodiment is not necessarily limited thereto. For example, another configuration may be taken instead in which only the last name of a user is stored as the addressee in the addressee specifying item 32 and retrieval is made for the last name. Alternatively, yet another configuration may be taken in which, for example, an ID and a nickname of a user are stored in the addressee specifying item 32 and retrieval is made for them.

It is apparent that the present invention is not necessarily limited to the above embodiments and the embodiments may be properly modified within the scope of the technical idea of the present invention.

What is claimed is:

1. An electronic mail sending device able to set a destination of an electronic mail address using address data in which a plurality of address records are previously registered, comprising:
the address records in which a group information composed of a plurality of group items are registered together with the destination; and
a mail generation means that compares a common item in the group information whose destination has already been set with the group information whose destination is newly designated when the new destination is designated in a state where the destination has already been set, and notifies a warning when both group information is inconsistent with each other.

2. The electronic mail sending device according to claim 1, wherein
a plurality of addressee specifying items specifying an addressee are registered together with the destination in the address record, and
the mail generation means that retrieves the address record having the common item, and notifies, as a guide destination, the address record having the same destination as the destination of the newly designated destination in any one item of the addressee specifying item when the common item of the group information whose destination has already been set is inconsistent with the group information whose destination is newly designated.

3. The electronic mail sending device according to claim 2, wherein
a last name and a first name of the addressee are registered as the addressee specifying item in the address record, and
the mail generation means retrieves the address record having the common item, and notifies, as a guide destination, the address record having the same destination as the destination of the newly designated destination in last name of the addressee when the common item in the group information whose destination has already been set is inconsistent with the group information whose destination is newly designated.
